(19) United States
(12) Patent Application Publication
(10) Pub. No.: US 2010/0245497 A1
(43) Pub. Date: Sep. 30, 2010

(54) BUFFER AND LIQUID EJECTING APPARATUS

(75) Inventor: Hirokazu Ono, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/729,435

(22) Filed: Mar. 23, 2010

(30) Foreign Application Priority Data
Mar. 26, 2009 (JP) 2009-076321

(51) Int. Cl. B41J 2/175; F16K 21/00

(52) U.S. Cl. 347/85; 251/331

(57) ABSTRACT

A buffer receiving and supplying liquid includes: a cylindrical cup having a bottom; and a flexible film forming a sealed space between the cup and the film, wherein one of a depressed portion and a projecting portion is formed at an open end of the cup, and wherein the film is attached to the open end and one of the depressed portion and the projecting portion along the surface thereof.

This application claims the benefit of Japanese Patent Application No. 2009-076321, filed Mar. 26, 2009, which is expressly incorporated herein by reference in its entirety.

### BACKGROUND

1. Technical Field

The present invention relates to a buffer and a liquid ejecting apparatus.

2. Related Art

A liquid ejecting apparatus which ejects liquid such as ink from a liquid ejecting head and places a liquid droplet on a recording medium to record characters, images or the like has been known in the past.

As shown in JP-A-2007-21996, a liquid ejecting apparatus is provided with a buffer receiving a certain amount of liquid in order to maintain the stable supply of liquid to a liquid ejecting head.

The buffer disclosed in JP-A-2007-21996 is disposed on a side of the liquid ejecting head, the side being opposite to a side where a nozzle is provided. The buffer has a flexible film. A sealed liquid chamber is formed between the film and the liquid ejecting head. Liquid is supplied from a main tank containing the liquid to the liquid chamber during normal operation. In the case where the liquid chamber is filled with the liquid, the film is expanded into a substantially domed shape in the direction opposite to the nozzle. Accordingly, it is possible to contain the liquid in the liquid chamber expanded into a dome shape.

In the case where a main tank is replaced, for example, the supply of liquid from the main tank to the liquid chamber is first stopped. Subsequently, the liquid contained in the liquid chamber expanded into the dome shape is supplied to the liquid ejecting head. Because the film has flexibility, it is possible for the buffer to supply the liquid ejecting head with the liquid until the film is transformed into a concave shape hollowing toward the nozzle. Accordingly, even when it is difficult to supply the liquid from the main tank to the liquid ejecting head, the buffer enables the liquid ejecting head to be stably supplied with the liquid.

The above related art has the following problems.

In the case where the supply of liquid from the main tank to the liquid chamber is stopped and liquid is supplied from the liquid chamber expanded into the dome shape to the liquid ejecting head, negative pressure is caused in the liquid chamber. Accordingly, the film expanded into the dome shape is subjected to force directed from outside of the film toward inside of the film by atmospheric pressure. However, because the force is dispersed along the surface of the film, the dome shaped film temporarily withstands the atmospheric pressure, so that the film is not immediately shrunk. In order to shrink the film, pressure in the liquid chamber should be decreased to a predetermined pressure. As a result, when liquid has begun to be supplied from the liquid chamber expanded into the dome shape, there is a risk that the supply of liquid for the liquid ejecting is temporarily unstable.

### SUMMARY

An advantage of some aspects of the invention is to provide a buffer and a liquid ejecting apparatus in which it is possible to maintain the stable supply of liquid for a liquid ejecting head.

In order to solve the above-mentioned problems, the invention adopts the following methods.

According to an aspect of the invention, there is provided a buffer receiving and supplying liquid. The buffer includes a cylindrical cup having a bottom and includes a flexible film forming a sealed space between the cup and the flexible film. A depressed portion or projecting portion is formed at an open end of the cup. The film is attached to the open end and the depressed portion or the projecting portion along the surface thereof.

According to the aspect of the invention having such configuration, in the case where the sealed space of the buffer is supplied with liquid from a main tank, the film is expanded into a substantially domed shape in a direction of the opening of the cup. Accordingly, the sealed space is also expanded into a dome shape to contain liquid therein. Because the depressed portion or the projecting portion is formed at the open end of the cup, the dome of the film has a groove along the depressed portion or a peak along the projecting portion.

In the case where it is difficult to supply the buffer with liquid from the main tank due to replacement of the main tank or the like, the liquid contained in the expanded sealed space is supplied to a liquid ejecting head. In this case, force is applied to the film by atmospheric pressure, and then the force is dispersed in a direction along the surface of the film as in the case of the related art. However, in the invention, the groove or the peak is formed on the surface of the film, and resistance to the force which shrinks the dome shaped film is reduced at the groove and peak, so that the dome of the film begins to shrink in the vicinity of the groove or the peak. Consequently, in the case where the buffer has begun to supply the liquid ejecting head with liquid, the film expanded into the substantially domed shape begins to shrink immediately.

It is preferable that the depressed portion or the projecting portion have a curved surface formed around a predetermined axis orthogonally intersecting an axial direction of the cup.

In the invention having such configuration, the curve of the film is gentle at the groove and the peak formed on the film expanded into the substantially domed shape. As a result, the film is not excessively fatigued, so that the lifetime of the film is prolonged.

It is preferable that a boundary portion between the open end and the depressed portion or projecting portion has a curved surface.

In the invention having such configuration, a boundary portion between the groove or the peak, which is formed on the film expanded into the substantially domed shape, and the other portion of a surface of the film has a curved surface. Accordingly, the curve of the film at the boundary portion is gentle. As a result, the film is not excessively fatigued, so that the lifetime of the film is prolonged.

It is preferable that the depressed portion or the projecting portion be formed to be wider toward the center of the cup.

In the invention having such configuration, in the case where the depressed portion is formed at an open end of the cup, a large groove is formed on the film expanded into the substantially domed shape. A larger groove leads to further decreasing the resistance of film to the force shrinking the dome shaped film, the force being caused when liquid has begun to be supplied from the buffer. As a result, when the buffer has begun to supply the liquid ejecting head with liquid, the film expanded into the substantially domed shape immediately begins to shrink. On the other hand, in the case where the projecting portion is formed at an open end of the cup, a large peak is formed on the film expanded into the substantially domed shape. Because the peak has a shape expanding in a direction of the opening of the cup, it is possible to set the volume of the buffer to be large.

It is preferable that the depressed portion or the projecting portion be formed to be narrower toward the center of the cup.

In the invention having such configuration, a small groove or peak is formed on the film expanded into the substantially domed shape. A small groove or peak enables the dome shape of the film to be a substantially spherical surface, so that it is possible to set the volume of the buffer to be large when the film has been expanded.

According to another aspect of the invention, there is provided a liquid ejecting apparatus including the buffer according to any of the above aspects of the invention.

In the invention having such configuration, when the buffer has begun to supply the liquid ejection head with liquid, the film expanded into the substantially domed shape immediately begins to shrink.

### BRIEF DESCRIPTION OF THE DRAWINGS

The invention will be described with reference to the accompanying drawings, wherein like numbers reference like elements.

FIG. 1 is a diagram illustrating the configuration of a printer.

FIG. 2 is a schematic view illustrating an ink supply system.

FIG. 3A is a plan view illustrating a buffer.

FIG. 3B is an elevation view illustrating the buffer.

FIG. 3C is a cross sectional view taken along a line IIIC-IIIC in FIG. 3B.

FIG. 4A is an elevation view of a buffer.

FIG. 4B is a cross sectional view taken along a line IVB-IVB in FIG. 4A.

FIG. 5A is an elevation view of a buffer.

FIG. 5B is a cross sectional view taken along a line VB-VB in FIG. 5A.

FIG. 6A is a plan view of a first modification of a buffer.

FIG. 6B is an elevation view of the first modification of the buffer.

FIG. 7A is a plan view of a second modification of a buffer.

FIG. 7B is an elevation view of the second modification of the buffer.

FIG. 8A is a plan view of a third modification of a buffer.

FIG. 8B is an elevation view of the third modification of the buffer.

FIG. 9A is a plan view of a fourth modification of a buffer.

FIG. 9B is an elevation view of the fourth modification of the buffer.

FIG. 9C is a cross sectional view taken along a line IXC-IXC in FIG. 9B.

### DESCRIPTION OF EXEMPLARY EMBODIMENTS

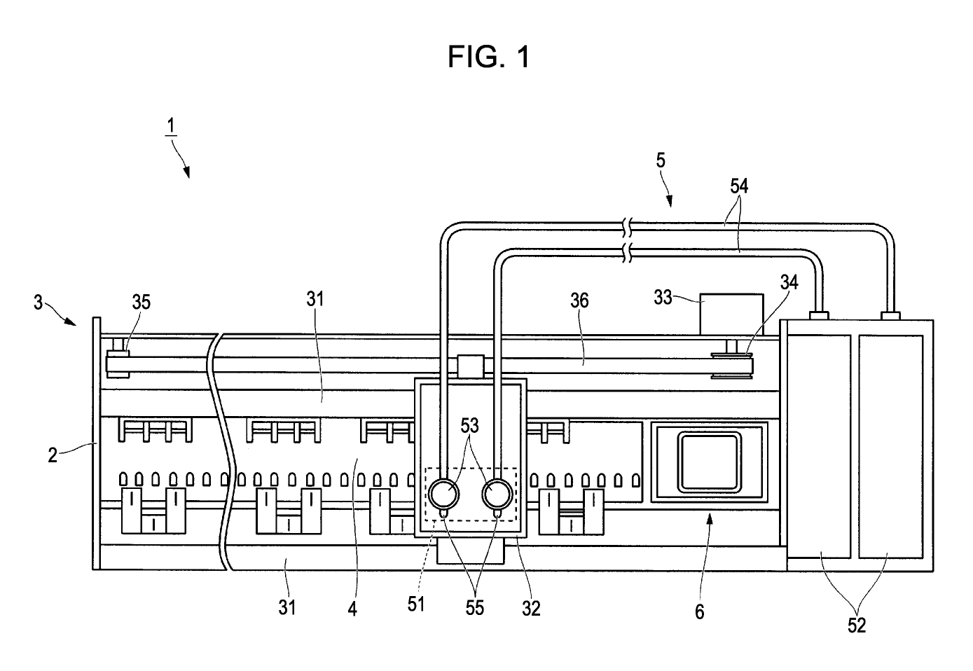

Embodiments of a buffer and a liquid ejecting apparatus of the invention will be described below with reference to FIGS. 1 to 9C. In figures used for the following explanation, the size of each member is appropriately changed in order to illustrate each member to be recognized.

In addition, in the embodiments, an ink jet printer (hereinafter referred to as a “printer”) in which ink (liquid) is ejected to be placed on paper or other recording media to record characters, images or the like will be described as an example of a liquid ejecting apparatus.

FIG. 1 is a diagram illustrating the configuration of a printer 1 according to the embodiment.

In the printer (liquid ejecting apparatus) 1, ink (liquid) is ejected to be placed on paper or other recording media to record characters, images or the like. The printer 1 includes a printer body 2, a carriage drive system 3, a platen 4, an ink supply system 5, and a capping unit 6.

The printer body 2 extends in a horizontal direction of FIG. 1. The printer body 2 is a member as a base of the printer 1 and includes the carriage drive system 3. The horizontal direction in FIG. 1 will be referred to as “horizontal direction” hereinafter.

The carriage drive system 3 is a drive system for moving a carriage 32 to be described later and includes a guide 31, the carriage 32, a motor 33, a drive pulley 34, a driven pulley 35, and a drive belt 36.

The guide 31 is a pair of members provided on the printer body 2 and extending in the horizontal direction.

The carriage 32 is provided with an ejection head 51 and a buffer 53 to be described later and is provided on the pair of the guides 31 so as to be able to move in the horizontal direction.

The motor 33 is an electrical motor provided on the printer body 2 and moves the carriage 32. The drive pulley 34 is integrally connected to the rotating shaft of the motor 33. The drive belt 36 is looped over the drive pulley 34. The driven pulley 35 is provided rotationally on the printer body 2. The drive belt 36 is looped over the driven pulley 35.

The drive belt 36 is looped over the drive pulley 34 and the driven pulley 35 and moves the carriage 32 in the horizontal direction by driving the motor 33. The drive belt 36 is integrally connected to the carriage 32 at a predetermined position. Accordingly, the driving of the motor 33 rotates the drive pulley 34, so that the drive belt 36 looped over the drive pulley 34 is moved in a predetermined direction. Because the carriage 32 is integrally connected to the drive belt 36, the movement of the drive belt 36 leads to the movement of the carriage 32.

The platen 4 is a supporting member for supporting paper or the like as a recording medium in a planar state. The printer body 2 is provided with a transport unit (not shown). The recording medium is transported on the platen 4 by the operation of the transport unit.

The ink supply system 5 includes the ejection head 51, a main tank 52, the buffer 53, a first supply tube 54, and a second supply tube 55.

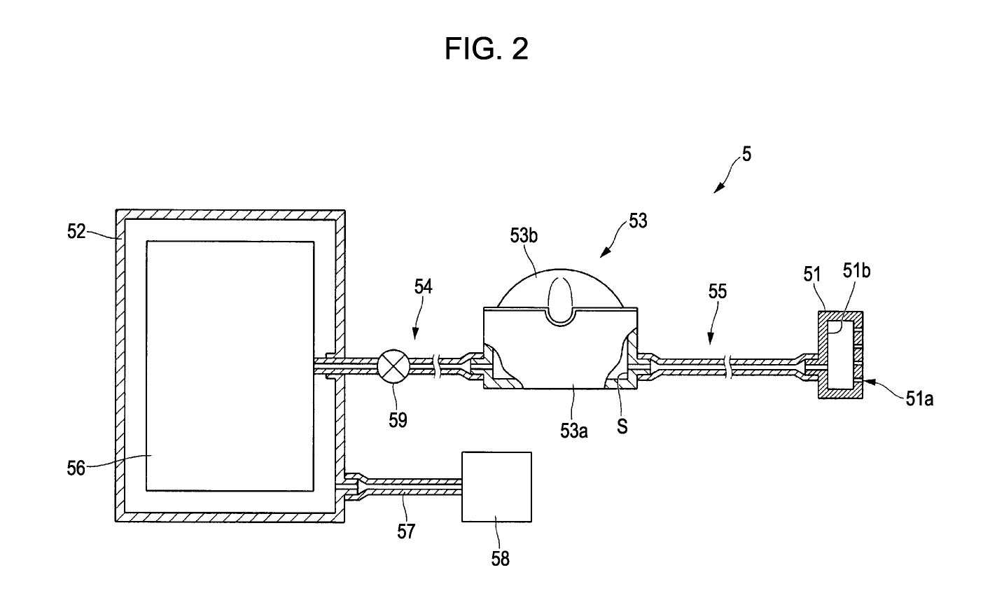

The ejection head 51 ejects ink from a plurality of nozzles 51a (see FIG. 2) to land an ink droplet on a recording medium. The ejection head 51 is disposed on the lower surface of the carriage 32 and faces the platen 4.

The main tank 52 is a container containing ink supplied for the ejection head 51. The printer body 2 includes a plurality of main tanks 52.

The buffer 53 contains a certain amount of ink to maintain the stable supply of the ink to the ejection head 51. A plurality of buffers 53 are provided on the upper surface of the carriage 32.

The first supply tubes 54 are individually provided between the plurality of main tanks 52 and the plurality of buffers 53 to supply the buffers 53 with the ink from the main tanks 52. In addition, because the carriage 32 is moved, the first tubes 54 are made of a flexible material such as an elastomer.

The second supply tubes 55 are individually provided between the ejection head 51 and the plurality of buffers 53 to supply the ejection head 51 with ink from the buffers 53.

The capping unit 6 suctions ink from the nozzle 51a of the ejection head 51 for cleaning and is disposed at a so-called home position of the printer body 2. The home position is a region within the moving range of the carriage 32 and outside a range in which the platen 4 supports a recording medium. The capping unit 6 cleans the ejection head 51 in the case where ink ejection is not performed in the printer 1 for a long time.

The ink supply system 5 will be described in detail with reference to FIG. 2.

FIG. 2 is a schematic view illustrating the ink supply system 5 according to the embodiment.

The ejection head 51 includes a plurality of nozzles 51a for ejecting ink, a liquid reservoir 51b for storing ink, and a piezoelectric device (not shown) which oscillates when a driving signal is applied thereto, each of the plurality of nozzles 51a being provided with the piezoelectric device.

The main tank 52 has an enclosed interior space. The interior space is provided with a removable ink package 56 for containing ink in a sealed state. The ink package 56 is formed into a bag-like container using a flexible resin, for example, and is in communication with the first supply tube 54.

The main tank 52 is connected to a pump 58 through a pump tube 57. The pump 58 pumps air into the main tank 52. The pump tube 57 is in communication with the interior space of the main tank 52, but is not in any communication with the main package 56.

The first supply tube 54 is provided with a valve 59. The valve 59 is an on-off valve being able to open and close the first supply tube 54.

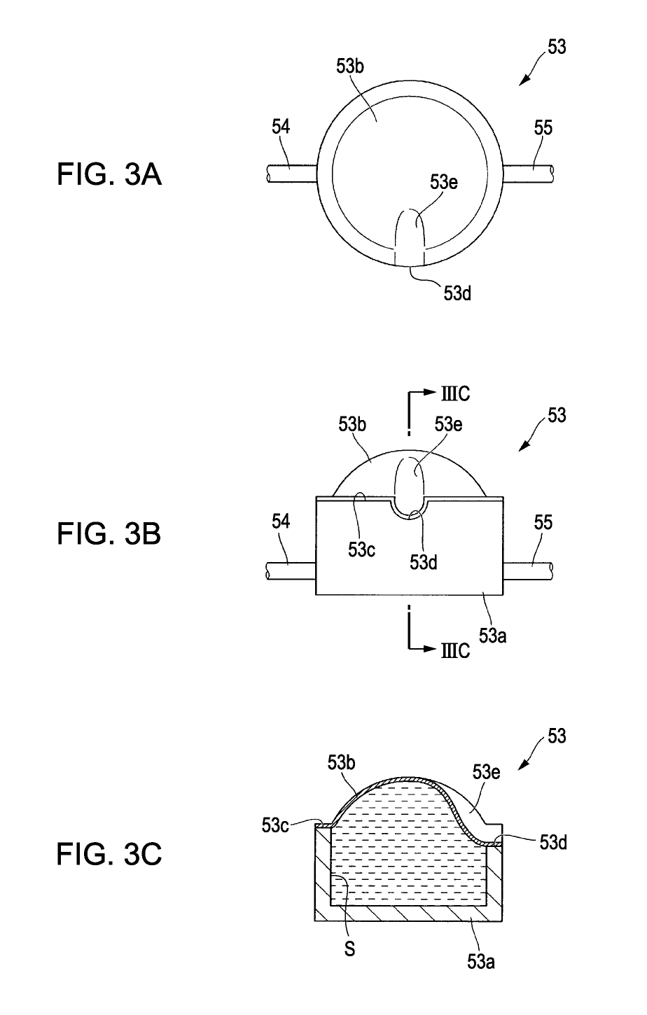

The buffer 53 includes a substantially cylindrical shaped cup 53a having a bottom and includes a flexible film 53b forming a sealed space S that contains ink between the cup 53a and the film 53b. The cup 53a is connected to both of the first supply tube 54 and the second supply tube 55. The buffer 53 will be described in detail with reference to FIGS. 3A to 3C.

FIGS. 3A to 3C schematically illustrates the buffer 53. FIG. 3A is a plan view illustrating the buffer 53. FIG. 3B is an elevation view illustrating the buffer 53. FIG. 3C is a cross sectional view taken along a line IIIC-IIIC in FIG. 3B. The buffer 53 in FIGS. 3A to 3C illustrates a state in which the sealed space S is fully filled with ink.

The cup 53a is formed into a substantially cylindrical shape having a bottom as described above. A depressed portion 53d is formed at an open end 53c of the cup 53a. The depressed portion 53d has a curved surface formed around a predetermined axis orthogonally intersecting an axial direction of the cup 53a.

The film 53b is a sheet member formed of a material having flexibility and inelasticity. The film 53b is attached to the edge of the open end 53c and the depressed portion 53d along the surface thereof. The center of the film 53b has a sagged shape compared to the edge thereof, and the center is configured so as to be able to move within a predetermined range with respect to the axial direction of the cup 53a.

With reference to FIGS. 3A to 3C, in a state in which the buffer 53 is fully filled with ink, the film 53b is expanded into a substantially domed shape in a direction of the opening of the cup 53a, and a groove 53e is formed on the film 53b.

The operation of the printer 1 according to the embodiment will be described. Because the buffer 53 and the ink supply system 5 of the invention have features of the invention, description of general operation of the printer 1 will be omitted and the operation of the ink supply system 5 will be described hereinafter.

With reference to FIGS. 2 and 3A to 3C, a process for filling the buffer 53 with ink will be described.

The valve 59 is first operated to open the first supply tube 54. In that state, the pump 58 is operated to pump air into the interior space of the main tank 52.

Because pressure in the interior space of the main tank 52 is increased, pressure is externally applied to the ink package 56, so that the buffer 53 is supplied with ink contained in the ink package 56 through the first supply tube 54. The ink thus supplied to the buffer 53 is supplied to the liquid reservoir 51b of the ejection head 51 through the second supply tube 55. Droplets of the ink filling the liquid reservoir 51b are ejected from the nozzle 51a by the driving of the piezoelectric device (not shown), resulting in landing on a recording medium to record characters, images or the like.

Ink is ejected from the nozzle 51a as described above, so that ink stored in the liquid reservoir 51b is gradually reduced. Because a flow rate of ink by the operation of the pump 58 is higher than that of ink used in the ejection head 51, ink continues to flow into the buffer 53 after the liquid reservoir 51b has been fully filled with ink. By virtue of the flow of ink, positive pressure is caused in the sealed space S of the buffer 53, so that the center of the film 53b is extruded toward the outside to expand into the substantially domed shape.

With reference to FIGS. 3A to 3C, the depressed portion 53d is formed at the open end 53c of the cup 53a. Because the film 53b is attached to the depressed portion 53d along the shape thereof, the groove 53e continuously extending from the depressed portion 53d is formed on the film 53b expanded into a dome shape. Because the depressed portion 53d has a curved surface formed around a predetermined axis orthogonally intersecting an axial direction of the cup 53a, the groove 53e also has such a curved surface.

Then, the process for filling the buffer 53 with ink is finished.

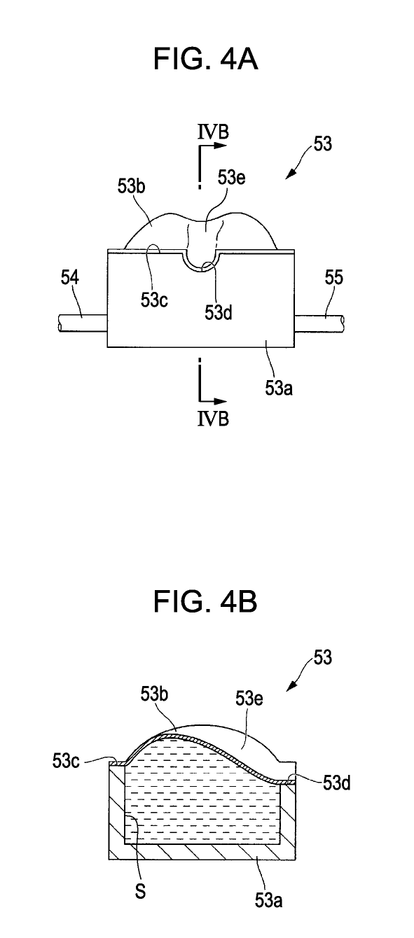

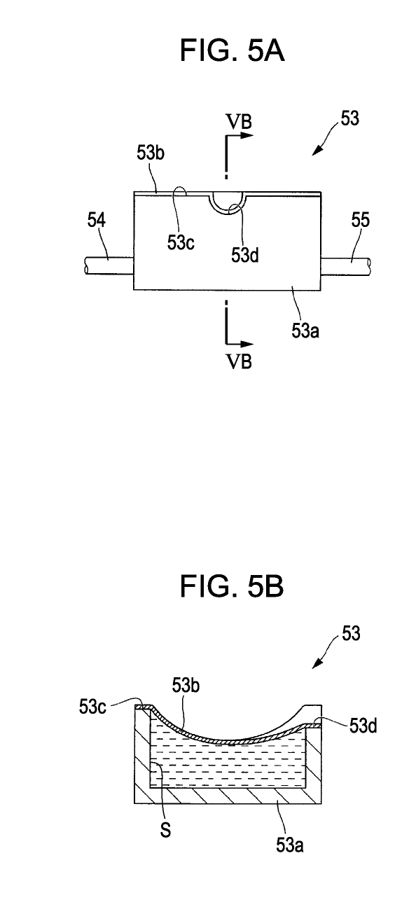

A set of the operation of the buffer 53 during the replacement of the ink package 56 will be described with reference to FIGS. 4A, 4B, 5A, and 5B.

FIGS. 4A and 4B schematically illustrate a state of the buffer 53 in the case where the supply of ink has started. FIG. 4A is an elevation view of the buffer 53. FIG. 4B is a cross sectional view taken along a line IVB-IVB in FIG. 4A.

FIGS. 5A and 5B schematically illustrate a state of the buffer 53 in the case where the supply of ink has finished. FIG. 5A is an elevation view of the buffer 53. FIG. 5B is a cross sectional view taken along a line VB-VB in FIG. 5A.

In the ink supply system 5 shown in FIG. 2, in the case where ink continues to be ejected from the ejection head 51, ink contained in the ink package 56 is gradually reduced. Therefore, the ink package 56 should be replaced with a new one before ink in the ink package 56 has been completely used.

In the case of the replacement of the ink package 56, the valve 59 is operated to close the first supply tube 54 in order to prevent air from entering the first supply tube 54. The ink package 56 is removed from the main tank 52 after the first supply tube 54 has been closed.

Because the first supply tube 54 is closed during the replacement of the ink package 56, the buffer 53 is not supplied with ink through the first supply tube 54. However, the ink ejection head 51 continues the ejection of ink and recording operation in view of productivity even when the ink package 56 is being replaced. Therefore, the ejection head 51 is supplied with ink contained in the buffer 53 during the replacement.

In other words, because ink is ejected from the nozzle 51a of the ejection head 51, ink in the liquid reservoir 51b is used, and because the liquid reservoir 51b is in communication with the buffer 53 through the second supply tube 55, negative pressure is caused in the sealed space S of the buffer 53. Consequently, the ejection head 51 begins to be supplied with ink contained in the buffer 53.

In the case where the film 53b expanded into the dome shape has a substantially spherical surface, even though force by atmospheric pressure is applied to the film 53b from outside the film 53b, the force is dispersed in a direction along the surface of the film 53b. Consequently, the film 53b expanded into the dome shape does not immediately shrink, so that ink may not be stably supplied.

However, in the embodiment, the groove 53e is formed on the dome shaped film 53b. Accordingly, as illustrated in FIGS. 4A and 4B, the groove 53e and the film 53b in the vicinity of the groove 53e have low resistance to the force shrinking the film 53b expanded into the dome shape. Consequently, in the case where ink in the buffer 53 begins to be supplied, the film 53b expanded into the dome shape begins to deform at the groove 53e and in the vicinity of the groove 53e, resulting in immediately beginning to shrink.

As a result, the supply of ink from the buffer 53 to the ejection head 51 is not interrupted, so that the stable supply of ink is maintained.

In the case where ink further continues to be supplied from the buffer 53, the film 53b is depressed in the inverse direction with respect to the opening of the cup 53a as shown in FIGS. 5A and 5B. It is possible for the buffer 53 to supply the ejection head 51 with ink until such a situation occurs. Consequently, the replacement of the ink package 56 should be finished before the buffer 53 comes into the state shown in FIGS. 5A and 5B.

After the main tank 52 is provided with a new ink package 56 which is filled with ink, the valve 59 is opened, and then the pump 58 is operated to supply the buffer 53 with ink from the main tank 52 again. The buffer 53 is filled with ink, so that the film 53b is expanded into the substantially domed shape shown in FIGS. 3A to 3C again.

Then, a set of the operation of the buffer 53 during the replacement of the ink package 56 has finished.

As described above, the center of the film 53b is reciprocated in the axial direction of the cup 53a during the replacement of the ink package 56. The depressed portion 53d has a curved surface. Because the film 53b is attached to the depressed portion 53d along the surface thereof, the curve of the film 53b is gentle at the groove 53e. Consequently, the reciprocating movement of the film 53b does not excessively fatigue the film 53b, so that the lifetime of the film 53b is prolonged.

Thus, it is possible to take the following advantage by virtue of the invention.

According to the embodiment, in the case where the valve 59 is closed to supply the ejection head 51 with ink contained in the buffer 53, it is possible to immediately shrink the film 53b expanded into the substantially domed shape, so that it is possible to maintain the stable supply of the ink for the ejection head 51.

Although the preferred embodiments have been described with reference to appended drawings, it should be understood that the invention is not limited to such embodiments. The shape and combination of members described above are an example, and it is possible to be modified within a scope not departing from the spirit of the invention on the basis of design requirements or the like.

For example, although ink is used as liquid ejected from the ejection head 51 onto a recording medium in the embodiment, the liquid is not limited thereto. It may be a functional fluid of which fine metal particles are dispersed in a solvent. Accordingly the invention may be applied to an apparatus for ejecting and placing a functional fluid onto a substrate to form a metal interconnection.

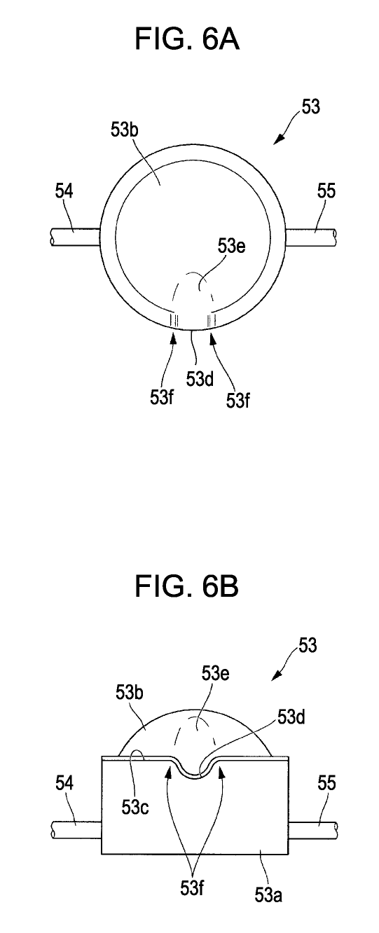

The buffer 53 of the above embodiment may employ a shape shown in FIGS. 6A and 6B.

FIGS. 6A and 6B schematically illustrate a first modification of the buffer 53. FIG. 6A is a plan view of the first modification of the buffer 53. FIG. 6B is an elevation view of the first modification of the buffer 53.

In the first modification of the buffer 53, a boundary portion 53f between the open end 53c and the depressed portion 53d has a curved surface. Consequently, a boundary portion between the groove 53e of the film 53b and the other portion of the film 53b also has a curved surface, so that the curve of the film 53b at the boundary portion is gentle. As a result, although the expansion and shrinkage of the film 53b is repeated, the film 53b is not excessively fatigued, so that it is possible to prolong the lifetime of the film 53b.

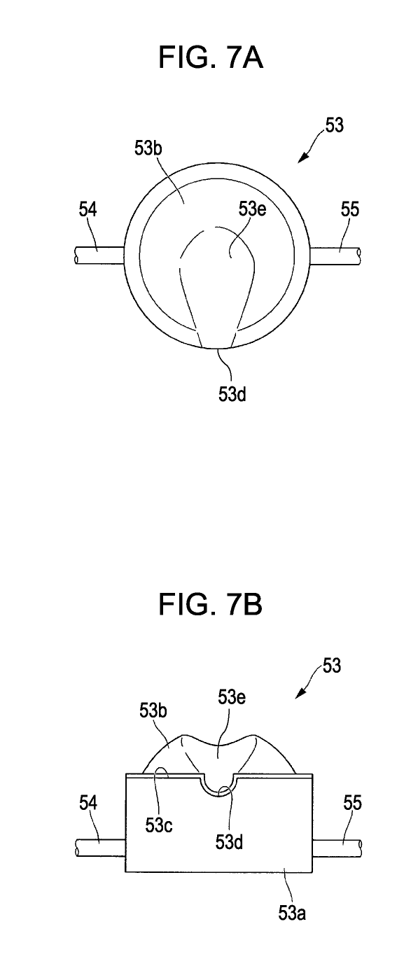

The buffer 53 of the above embodiments may employ a shape shown in FIGS. 7A and 7B.

FIGS. 7A and 7B schematically illustrate a second modification of the buffer 53. FIG. 7A is a plan view of the second modification of the buffer 53. FIG. 7B is an elevation view of the second modification of the buffer 53.

In the second modification of the buffer 53, the depressed portion 53d is formed so as to be wider toward the center of the cup 53a. Because the shape of the depressed portion 53d affects the shape of the groove 53e formed in the case of the expansion of the film 53b, a groove 53e larger than in the embodiment shown in FIGS. 3A and 3B is formed. The large groove 53e further decreases the resistance of the groove 53e and the vicinity of the groove 53e to the force shrinking the film 53b expanded into the substantially domed shape which is caused in the case where the buffer 53 has begun to supply ink. Consequently, in the case where the buffer 53 has begun to supply the ejection head 51 with ink, it is possible to further easily shrink the film 53b expanded into the dome shape.

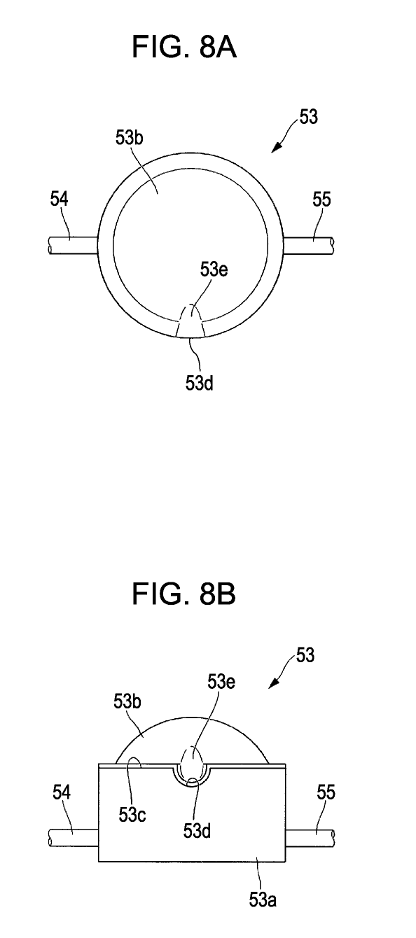

The buffer 53 of the above embodiments may employ a shape shown in FIGS. 8A and 8B.

FIGS. 8A and 8B schematically illustrate a third modification of the buffer 53. FIG. 8A is a plan view of the third modification of the buffer 53. FIG. 8B is an elevation view of the third modification of the buffer 53.

In the third modification of the buffer 53, the depressed portion 53d is formed so as to be narrower toward the center of the cup 53a. Accordingly, in the case of the expansion of the film 53b, a groove 53e smaller than in the embodiment shown in FIGS. 3A and 3B is formed. The shape of the film 53b becomes a substantially spherical surface in the case of the expansion of the film 53b due to the small groove 53e, so that it is possible to secure a large volume of the buffer 53 in the case of the expansion of the film 53b.

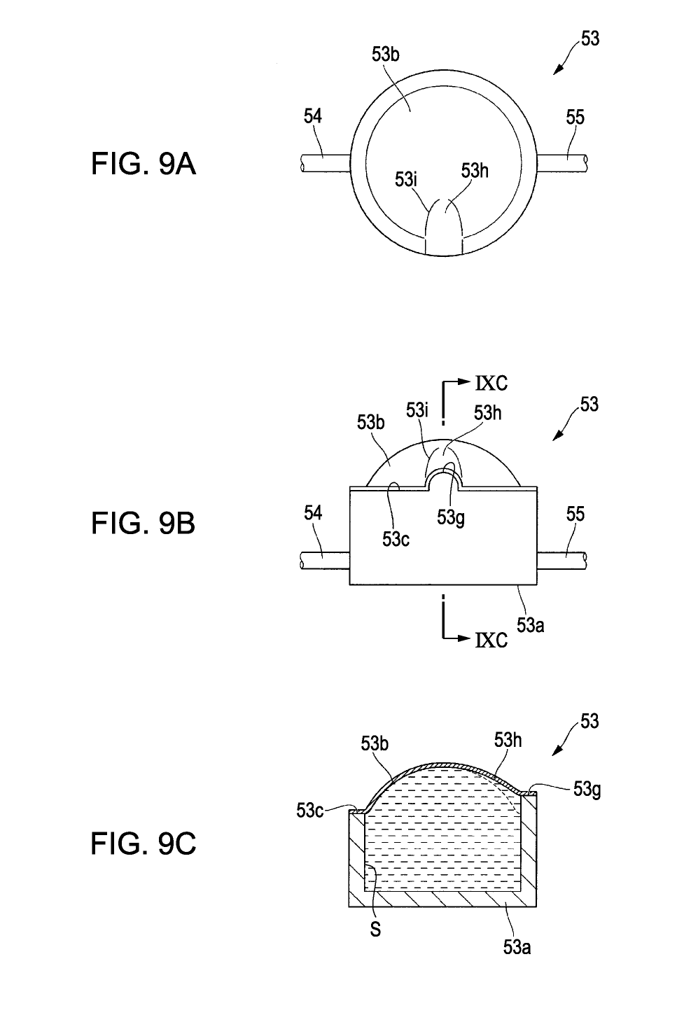

The buffer 53 of the above embodiments may employ a shape shown in FIGS. 9A, 9B, and 9C.

FIGS. 9A, 9B, and 9C schematically illustrate a fourth modification of the buffer 53. FIG. 9A is a plan view of the fourth modification of the buffer 53. FIG. 9B is an elevation view of the fourth modification of the buffer 53. FIG. 9C is a cross sectional view taken along a line IXC-IXC in FIG. 9B.

In the fourth modification of the buffer 53, a projecting portion 53g is formed at the open end 53c. In the case of the expansion of the film 53b, because the film 53b expands along the projecting portion 53g, a peak 53h continuously extending from the projecting portion 53g is formed on the film 53b. A boundary portion 53i between the peak 53h and the other portion of the film 53b becomes depressed.

As described above, in the case where the buffer 53 has begun to supply ink, force shrinking the film 53b expanded into a substantially domed shape is caused. The boundary portion 53i has low resistance to the force for shrinkage, so that the film 53b expanded into a dome shape begins to shrink at the boundary portion 53i immediately. Accordingly, in the case where the projecting portion 53g is formed at the open end 53c, it is also possible to maintain the stable supply of ink from the buffer 53 to the ejection head 51.

Although the cup 53a is formed into a substantially cylindrical shape in the above embodiments, the invention is not limited to the embodiments. It may be an angular shape whose cross section is polygonal.

What is claimed is:

1. A buffer receiving and supplying liquid, the buffer comprising:
a cylindrical cup having a bottom; and
a flexible film forming a sealed space between the cup and the film,
wherein one of a depressed portion and a projecting portion is formed at an open end of the cup, and
wherein the film is attached to the open end and one of the depressed portion and the projecting portion along a surface thereof.

2. The buffer according to claim 1, wherein one of the depressed portion and the projecting portion has a curved surface formed around a predetermined axis orthogonally intersecting an axial direction of the cup.

3. The buffer according to claim 1, wherein a boundary portion between the open end and one of the depressed portion and the projecting portion has a curved surface.

4. The buffer according to claim 1, wherein one of the depressed portion and the projecting portion is formed to be wider toward the center of the cup.

5. The buffer according to claim 1, wherein one of the depressed portion and the projecting portion is formed to be narrower toward a center of the cup.

6. A liquid ejecting apparatus, comprising:
a buffer receiving and supplying liquid, the buffer including:
a cylindrical cup having a bottom; and
a flexible film forming a sealed space between the cup and the film,
wherein one of a depressed portion and a projecting portion is formed at an open end of the cup, and
wherein the film is attached to the open end and one of the depressed portion and the projecting portion along a surface thereof.

7. The liquid ejecting apparatus according to claim 6, wherein one of the depressed portion and the projecting portion has a curved surface formed around a predetermined axis orthogonally intersecting an axial direction of the cup.

8. The liquid ejecting apparatus according to claim 6, wherein a boundary portion between the open end and one of the depressed portion and the projecting portion has a curved surface.

9. The liquid ejecting apparatus according to claim 6, wherein one of the depressed portion and the projecting portion is formed to be wider toward the center of the cup.

10. The liquid ejecting apparatus according to claim 6, wherein one of the depressed portion and the projecting portion is formed to be narrower toward a center of the cup.
